(19) United States
(12) Patent Application Publication
(10) Pub. No.: US 2026/0088354 A1
(43) Pub. Date: Mar. 26, 2026

(54) ELECTROLYTE SOLUTION FOR LITHIUM SECONDARY BATTERY, SECONDARY BATTERY, AND ELECTRICAL DEVICE

(71) Applicant: CONTEMPORARY AMPEREX TECHNOLOGY CO., LIMITED, Ningde (CN)

(72) Inventors: Zeli WU, Ningde (CN); Changlong HAN, Ningde (CN); Qiao WU, Ningde (CN); Jie GUO, Ningde (CN); Wenhao LIU, Ningde (CN); Lei HUANG, Ningde (CN); Cuiping ZHANG, Ningde (CN); Peng FAN, Ningde (CN); Yilin DENG, Ningde (CN)

(73) Assignee: CONTEMPORARY AMPEREX TECHNOLOGY CO., LIMITED, Ningde (CN)

(21) Appl. No.: 19/399,467

(22) Filed: Nov. 24, 2025

Related U.S. Application Data
(63) Continuation of application No. PCT/CN2023/097821, filed on Jun. 1, 2023.

(51) Int. Cl. H01M 10/0567; H01M 4/02; H01M 4/525; H01M 10/052; H01M 10/0568; H01M 10/0569

(52) U.S. Cl. CPC H01M 10/0567; H01M 4/525; H01M 10/052; H01M 10/0568; H01M 10/0569; H01M 2004/021; H01M 2004/028; H01M 2300/0037

(57) ABSTRACT

The present application discloses an electrolyte solution for a lithium secondary battery, a secondary battery, and an electrical device. The electrolyte solution for a lithium secondary battery includes a sulfate and fluorosulfonate ions, and a molar ratio of the sulfate to the fluorosulfonate ions is (8-223):1.

### CROSS-REFERENCE TO RELATED APPLICATIONS

This application is a continuation of International application PCT/CN2023/097821 filed on Jun. 1, 2023, the content of which is incorporated by reference herein in its entirety.

### TECHNICAL FIELD

The present application relates to the technical field of secondary batteries, and particularly relates to an electrolyte solution for a lithium secondary battery, a secondary battery, and an electrical device.

### BACKGROUND

Secondary batteries have not only been applied to energy storage power source systems such as hydraulic, firepower, wind and solar power stations but have also widely applied to many fields, e.g., electric transportation vehicles such as electric bicycles, electric motorcycles, and electric automobiles, military equipment and aerospace.

However, after multiple cycles, the storage performance and cycling performance of the existing secondary batteries will significantly decrease, and the DC internal resistance will significantly increase.

### SUMMARY OF THE INVENTION

In view of the technical problems existing in the background, the present application provides an electrolyte solution for a lithium secondary battery, aiming to solve the problems that the storage performance and cycling performance significantly decrease and the DC internal resistance significantly increases after the secondary battery containing it undergoes multiple cycles.

In order to achieve the above purpose, the electrolyte solution for a lithium secondary battery includes sulfate and fluorosulfonate ions, and a molar ratio of the sulfate to the fluorosulfonate ions is (8-223):1.

The present application at least includes the following beneficial effects: the electrolyte solution for a lithium secondary battery includes the sulfate and the fluosulfonate ions, the electrolyte solution for a lithium secondary battery includes the sulfate and the fluosulfonate ions mixed according to the above ratio, and the sulfate and the fluosulfonate ions jointly participate in the formation of the positive and negative electrode interface film to form a dense composite film, thus improving the thermal stability and mechanical stability of the interface film, and playing a role of significantly improving the cycle life of the secondary battery; in addition, the formed interface film has strong ionic conductivity, thus reducing the DC internal resistance of the secondary battery. In this way, the simultaneous use of the sulfate and the fluorosulfonate ions can reduce the DC internal resistance of the secondary battery and improve the storage performance and cycling performance of the secondary battery.

In some embodiments of the present application, the molar ratio of the sulfate to the fluorosulfonate ions is (10-60):1, and optionally (16.7-50):1. In this way, the DC internal resistance of the secondary battery can be reduced, and the storage performance and cycling performance of the secondary battery can be improved.

In some embodiments of the present application, the molar concentration of the sulfate in the electrolyte solution for a lithium secondary battery is 0.08 mol/L-0.2 mol/L, and optionally 0.1 mol/L-0.15 mol/L. In this way, the molar concentration of the sulfate in the electrolyte solution for a lithium secondary battery is within the above range, thus reducing the DC internal resistance of the secondary battery and improving the storage performance and cycling performance of the secondary battery.

In some embodiments of the present application, the molar concentration of the fluorosulfonate ions in the electrolyte solution for a lithium secondary battery is 0.0009 mol/L-0.009 mol/L, and optionally 0.003 mol/L-0.006 mol/L. In this way, the molar concentration of the fluorosulfonate ions in the electrolyte solution for a lithium secondary battery is within the above range, thus reducing the DC internal resistance of the secondary battery and improving the storage performance and cycling performance of the secondary battery.

In some embodiments of the present application, the sulfate includes at least one of ethylene sulfate, 4-methyl ethylene sulfate, 4-fluoroethylene sulfate, 4-n-propyl ethylene sulfate, and 4,4′-bis(ethylene sulfate).

In some embodiments of the present application, the fluorosulfonate ions are ASO₃F, where A includes at least one of Li, Na, K, and H.

In some embodiments of the present application, the electrolyte solution for a lithium secondary battery further includes a positive electrode film-forming additive. In this way, the positive electrode film-forming additive can participate in the formation of the interface film on the positive electrode surface of the secondary battery, thus improving the storage performance and cycling performance of the secondary battery.

In some embodiments, the positive electrode film-forming additive includes at least one of fluoroethylene carbonate and 1,3-propanesultone. In this way, the positive electrode film-forming additive is one of the above substances and can participate in the formation of the film on the positive electrode surface of the secondary battery, thus improving the storage performance and cycling performance of the secondary battery.

In some embodiments of the present application, a ratio of the molar amount of the positive electrode film-forming additive to a sum of the molar amounts of the sulfate and the fluorosulfonate ions in the electrolyte solution for a lithium secondary battery is (0.05-0.37):1, and optionally (0.06-0.3):1. In this way, the ratio of the molar amount of the positive electrode film-forming additive in the electrolyte solution for a lithium secondary battery to the sum of the molar amounts of the sulfate and the fluosulfonate ion is within the above range, thus participating in the formation of the interface film on the positive electrode surface of the secondary battery, and improving the storage performance and cycling performance of the secondary battery.

In some embodiments of the present application, the molar concentration of the positive electrode film-forming additive in the electrolyte solution for a lithium secondary battery is 0.01 mol/L-0.03 mol/L. In this way, the concentration of the positive electrode film-forming additive in the electrolyte solution for a lithium secondary battery is within the above range, thus participating in the formation of the interface film on the positive electrode surface of the secondary battery, and improving the storage performance and cycling performance of the secondary battery.

In some embodiments of the present application, the electrolyte solution for a lithium secondary battery further includes difluorophosphate ions. In this way, the solvation structure of the electrolyte solution for a lithium secondary battery can be changed, so that more alkali metal ions participate in the film formation, thus improving the ionic conductivity of the interface film. In addition, the difluorophosphate ions, fluosulfonate ions, and sulfate jointly participate in the formation of the positive and negative electrode interface film, thus improving the thermal stability of the interface film, reducing the DC internal resistance of the secondary battery, and improving the storage performance and cycling performance of the secondary battery.

In some embodiments of the present application, a ratio of the molar amount of the difluorophosphate ions to a sum of the molar amounts of the sulfate and the fluorosulfonate ions is (0.048-1):1, and optionally (0.13-0.58):1. In this way, the ratio of the molar amount of the difluorophosphate ions in the electrolyte solution for a lithium secondary battery to the sum of the molar amounts of the sulfate and the fluorosulfonate ions is within the above range, thus reducing the DC internal resistance of the secondary battery and improving the storage performance and cycling performance of the secondary battery.

In some embodiments of the present application, the molar concentration of the difluorophosphate ions is 0.01 mol/L-0.08 mol/L, and optionally 0.02 mol/L-0.06 mol/L. In this way, the molar concentration of the difluorophosphate ions in the electrolyte solution for a lithium secondary battery is within the above range, thus reducing the DC internal resistance of the secondary battery and improving the storage performance and cycling performance of the secondary battery.

In some embodiments of the present application, the difluorophosphate ions are MPO₂F₂, where M includes at least one of Li, Na, K, and H.

In some embodiments of the present application, the electrolyte solution for a lithium secondary battery further includes tetrafluoroborate ions. The tetrafluoroborate ions are compatible with the electrolyte solution system for the lithium secondary battery can participate in the formation of the negative electrode interface film of the secondary battery, thus opening the ion channel, and reducing the DC internal resistance of the secondary battery.

In some embodiments of the present application, a ratio of the molar amount of the tetrafluoroborate ions to a sum of the molar amounts of the sulfate and the fluorosulfonate ions in the electrolyte solution for a lithium secondary battery is (0.0024-0.012):1, and optionally (0.0038-0.008):1. In this way, the ratio of the molar amount of the tetrafluoroborate ions in the electrolyte solution for a lithium secondary battery to the sum of the molar amounts of the sulfate and the fluosulfonate ion is within the above range, thus participating in the formation of the negative electrode interface film of the secondary battery, and improving the DC internal resistance of the secondary battery.

In some embodiments of the present application, the molar concentration of the tetrafluoroborate ions in the electrolyte solution for a lithium secondary battery is 0.0005 mol/L-0.001 mol/L, and optionally 0.0006 mol/L-0.0008 mol/L. In this way, the molar concentration of the tetrafluoroborate ions in the electrolyte solution for a lithium secondary battery is within the above range, thus participating in the formation of the negative electrode interface film of the secondary battery, and reducing the DC internal resistance of the secondary battery.

In some embodiments of the present application, the tetrafluoroborate ions are provided by at least one of the following substances: tetrafluoroboric acid, sodium tetrafluoroborate, potassium tetrafluoroborate, and lithium tetrafluoroborate.

In some embodiments of the present application, the content of water in the electrolyte solution for a lithium secondary battery is less than or equal to 20 ppm. In this way, the content of water in the electrolyte solution for a lithium secondary battery is within the above range, thus reducing the damage caused by water to the interface film especially at high voltage, and improving the storage performance and cycling performance of the secondary battery.

In some embodiments of the present application, the content of HF in the electrolyte solution for a lithium secondary battery is less than or equal to 150 ppm. In this way, the content of HF in the electrolyte solution for a lithium secondary battery is within the above range, thus reducing the damage caused by HF to the interface film especially at high voltage, and improving the storage performance and cycling performance of the secondary battery.

According to a second aspect, the present application provides a secondary battery, which includes the electrolyte solution for a lithium secondary battery according to the first aspect of the present application. In this way, the secondary battery has low DC internal resistance and excellent storage performance and cycling performance.

In some embodiments of the present application, the secondary battery includes a positive electrode active material, and the positive electrode active material includes LiₓNi_{(1-y-z)}Co_{y}M_{z}O_{2-b}, where M includes at least one of Mn, Al, Fe, Ti, Mg, Cr, Ga, Cu, Zn, Nb, and Zr, 0<x≤1.2, 0.05≤y≤0.8, 0.01≤z≤0.5, and 0≤b≤0.2.

In some embodiments of the present application, the BET specific surface area of the positive electrode active material is less than or equal to 3 m²/g, and optionally, the BET specific surface area of the positive electrode active material is 1 m²/g-2.5 m²/g.

According to a third aspect, the present application provides an electrical device, which includes the secondary battery according to the second aspect.

Additional aspects and advantages of the present application will be set forth in part in the description which follows, and in part will be obvious from the description which follows, or may be learned by practice of the present application.

### DESCRIPTION OF DRAWINGS

By reading the detailed description of the preferred embodiments below, various other advantages and benefits will become apparent to those of ordinary skill in the art. The drawings are used for the purpose of illustrating the preferred embodiments only and are not to be considered a limitation to the present application. Moreover, in all of the drawings, like reference numerals represent like components. In the figures:

FIG. 1 is a schematic structural diagram of a secondary battery according to an embodiment of the present application;

FIG. 2 is a schematic structural diagram of a battery module according to an embodiment of the present application;

FIG. 3 is a schematic structural diagram of a battery pack according to an embodiment of the present application;

FIG. 4 is an exploded diagram of FIG. 3; and

FIG. 5 is a schematic diagram of an electrical device in which a battery is used as a power source according to an embodiment.

### DESCRIPTION OF REFERENCE NUMERALS

1—secondary battery; 2—battery module; 3—battery pack; 4—upper box; 5—lower box

### DETAILED DESCRIPTION

The embodiments of the technical solution of the present application will be described in detail below. The following embodiments are only used to more clearly illustrate the technical solutions of the present application, therefore only as examples, and cannot be used to limit the scope of protection of the present application.

Reference to “an embodiment” herein means that a particular feature, structure, or characteristic described with reference to an embodiment can be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

For conciseness, only certain numerical ranges are explicitly disclosed herein. However, any lower limit can be combined with any upper limit to form a range that is not explicitly recited; any lower limit can be combined with another lower limit to form a range that is not explicitly recited; and any upper limit may be combined with another upper limit to form a range that is not explicitly recited. Additionally, each individually disclosed point or single numerical value may itself serve as a lower or upper limit to form a range not explicitly recited by combining with any other point or single numerical value, or with other lower or upper limits.

In the description of the embodiments of the present application, the term “and/or” is simply a description of an association of associated objects, which indicates that there may exist three relationships, for example, A and/or B may represent three situations: A exists alone, both A and B exist, and B exists alone. In addition, the character “/” herein generally means that the associated objects before and after it are in an “or” relationship.

Unless otherwise defined, all technical and scientific terms used herein have the same meaning as commonly understood by those skilled in the art belonging to the technical field of the present application; the terms used herein are intended only for the purpose of describing specific examples and are not intended to limit the present application; the terms “including” and “having” and any variations thereof in the specification and the claims of the present application and in the description of drawings above are intended to cover non-exclusive inclusion.

Secondary batteries have not only been applied to energy storage power source systems such as hydraulic, firepower, wind and solar power stations but have also widely applied to many fields, e.g., electric transportation vehicles such as electric bicycles, electric motorcycles, and electric automobiles, military equipment and aerospace. With the continuous expansion of the application field of the secondary power batteries, the market demand is also constantly expanding.

In the first charging and discharging process of the secondary battery, the electrode material (such as negative electrode active material) reacts with the electrolyte solution for a lithium secondary battery on a solid-liquid phase interface, forming a passivation layer covering the surface of the electrode material. This passivation layer is a kind of interface film, has the characteristics of solid electrolyte, and is an electron insulator but an excellent conductor of alkali metal ions. Alkali metal ions can be freely intercalated and deintercalated through the passivation layer. Therefore, this passivation film is called positive and negative electrode interface film.

However, the existing secondary battery has the following problems: on the one hand, with the charging and discharging cycle of the secondary battery, the interface film on the positive and negative electrode interface is unstable and easy to be damaged, and the transmission resistance of alkali metal ions will also become larger, resulting in the increase of the DC impedance of the secondary battery, and the deterioration of the storage performance and cycling performance; on the other hand, during the charging and discharging of the secondary battery, under high temperature and high pressure, the positive electrode active material has strong oxidizing properties and will oxidize the electrolyte solution for a lithium secondary battery to generate a large amount of gas, resulting in the loss of the electrolyte solution and positive electrode active material of the lithium secondary battery, and affecting the storage performance and cycling performance of the secondary battery.

The sulfate and the fluosulfonate ions jointly participate in the formation of the positive and negative electrode interface film to form a dense composite film, thus improving the thermal stability and mechanical stability of the interface film, and playing a role of significantly improving the cycle life of the secondary battery; in addition, the formed interface film has strong ionic conductivity, thus reducing the DC internal resistance of the secondary battery. In this way, the simultaneous use of the sulfate and the fluorosulfonate ions can reduce the DC internal resistance of the secondary battery and improve the storage performance and cycling performance of the secondary battery. On the other hand, the interface film has thermal stability and mechanical stability, thus reducing the probability that the interface film is ruptured, reducing the reaction between the positive electrode active material and the electrolyte solution for a lithium secondary battery, inhibiting the gas production of the secondary battery, reducing the loss of the electrolyte solution for a lithium secondary battery and the positive electrode active material, and improving the storage performance and cycling performance of the secondary battery.

The positive electrode active material disclosed in the embodiments of the present application is applicable to the secondary battery. The secondary battery disclosed in the embodiments of the present application can be used in an electrical device that uses the secondary battery as the power source or in various energy storage systems that use batteries as energy storage elements. The electrical device may include, but is not limited to, a mobile phone, a tablet, a laptop, an electric toy, an electric tool, a storage battery car, an electric vehicle, a ship, a spacecraft, etc. The electric toy may include fixed or mobile electric toys, such as a game machine, an electric vehicle toy, an electric ship toy, and an electric airplane toy. The spacecraft may include an airplane, a rocket, a space shuttle, a spaceship, and the like.

According to a first aspect, the present application provides an electrolyte solution for a lithium secondary battery, where the electrolyte solution for a lithium secondary battery includes a sulfate and fluorosulfonate ions, and a molar ratio of the sulfate to the fluorosulfonate ions is (8-223):1.

The present application at least includes the following beneficial effects: the electrolyte solution for a lithium secondary battery includes the sulfate and the fluosulfonate ions, the electrolyte solution for a lithium secondary battery includes the sulfate and the fluosulfonate ions mixed according to the above ratio, and the two jointly participate in the formation of the positive and negative electrode interface film to form a dense composite film, thus improving the thermal stability and mechanical stability of the interface film, and also improving the ionic conductivity of the interface film. In this way, the simultaneous use of the sulfate and the fluorosulfonate ions can reduce the DC internal resistance of the secondary battery and improve the storage performance and cycling performance of the secondary battery.

Direct current internal resistance (DCR) refers to the resistance experienced by the current inside the battery cell. After the discharging process of the secondary battery is completed, the voltage of the secondary battery will rebound due to polarization. DC impedance technology calculates the internal resistance of the secondary battery by using the difference between the voltage at the moment just before the discharging is completed and the stabilized voltage after the discharging is completed in the intermittent discharging process.

In some embodiments of the present application, the sulfate may include at least one of ethylene sulfate, 4-methyl ethylene sulfate, 4-fluoroethylene sulfate, 4-n-propyl ethylene sulfate, and 4,4′-bis(ethylene sulfate). In this way, by using the sulfate in the electrolyte solution for a lithium secondary battery in the present application, it can participate in the formation of the positive and negative electrode interface film, thus making the interface film flexible, adapting to the expansion and contraction of the electrode plate of the secondary battery in the cycling process, improving the mechanical stability of the interface film, improving the ionic conductivity of the interface film, improving the cycling performance of the secondary battery, and reducing the DC internal resistance. In some other embodiments of the present application, the sulphate includes 4,4′-bis(ethylene sulfate).

In some embodiments of the present application, the fluorosulfonate ions are ASO₃F, where A includes at least one of Li, Na, K, and H. Specifically, the substance containing the fluorosulfonate ions can provide the fluorosulfonate ions, and the interface formed by the participation of the fluorosulfonate ions is very dense and has good thermal stability, thus improving the storage performance of the secondary battery while reducing the DC impedance of the secondary battery.

In some embodiments of the present application, the molar ratio of the sulfate to the fluosulfonate ions may be (8.9-222):1, (10-200):1, (20-190):1, (30-180):1, (40-170):1, (50-160):1, (60-150):1, (70-140):1, (80-130):1, (90-120):1, (100-110):1, etc. In some other embodiments of the present application, the molar ratio of the sulfate to the fluosulfonate ions in the electrolyte solution for a lithium secondary battery is (10-60):1, for example (16.7-50):1. Specifically, when the molar ratio of the sulfate to the fluorosulfonate ions is within the above range, thus reducing the decrease of the thermal stability of the interface film since the amount of the sulfate is too large, improving the storage performance of the secondary battery, reducing the defects of insufficient formation of the interface film and poor ionic conductivity since the amount of the sulfate is too small, reducing the DC internal resistance of the secondary battery, and improving the storage performance and cycling performance of the secondary battery.

In some embodiments of the present application, the molar concentration of the sulfate in the electrolyte solution for a lithium secondary battery is 0.08 mol/L-0.2 mol/L. For example, the molar concentration of the sulfate in the electrolyte solution for a lithium secondary battery may be 0.04 mol/L-0.18 mol/L, 0.09 mol/L-0.17 mol/L, 0.1 mol/L-0.16 mol/L, 0.11 mol/L-0.15 mol/L, 0.12 mol/L-0.14 mol/L, etc. In this way, the molar concentration of the sulfate in the electrolyte solution for a lithium secondary battery is within the above range, thus reducing the decrease of the thermal stability of the interface film since the amount of the sulfate is too large, improving the storage performance of the secondary battery, reducing the defects of insufficient formation of the interface film and poor ionic conductivity since the amount of the sulfate is too small, reducing the DC internal resistance of the secondary battery, and improving the storage performance and cycling performance of the secondary battery. In some other embodiments of the present application, the molar concentration of the sulfate in the electrolyte solution for a lithium secondary battery is 0.1 mol/L-0.15 mol/L.

In some embodiments of the present application, the molar concentration of the fluorosulfonate ions in the electrolyte solution for a lithium secondary battery is 0.0009 mol/L-0.009 mol/L. For example, the molar concentration of the fluorosulfonate ions in the electrolyte solution for a lithium secondary battery may be 0.001 mol/L-0.009 mol/L, 0.002 mol/L-0.008 mol/L, 0.003 mol/L-0.007 mol/L, 0.004 mol/L-0.006 mol/L, etc. Specifically, the molar concentration of the fluorosulfonate ions in the electrolyte solution for a lithium secondary battery is within the above range, thus reducing the problem of the increase of the viscosity of the electrolyte solution for a lithium secondary battery caused by the addition of the substance containing the fluorosulfonate ions, reducing the DC internal resistance of the secondary battery, improving the thermal stability of the interface film, and improving the storage performance of the secondary battery. In some other embodiments of the present application, the molar concentration of the fluorosulfonate ions in the electrolyte solution for a lithium secondary battery is 0.003 mol/L-0.006 mol/L.

In some embodiments of the present application, the electrolyte solution for a lithium secondary battery further includes a positive electrode film-forming additive. Specifically, the positive electrode film-forming additive can participate in the formation of the stable positive electrode interface film, thus reducing the DC impedance of the secondary battery, and improving the cycling performance of the secondary battery.

In some embodiments, the positive electrode film-forming additive includes at least one of fluoroethylene carbonate and 1,3-propanesultone. Specifically, the positive electrode interface film formed with the participation of fluoroethylene carbonate and 1,3-propanesultone has excellent performance, thus forming a dense interface film without increasing the impedance, preventing the decomposition of the electrolyte solution for a lithium secondary battery, reducing the DC internal resistance of the secondary battery, and improving the storage performance and cycling performance of the secondary battery.

In some embodiments of the present application, a ratio of the molar amount of the positive electrode film-forming additive to the sum of the molar amounts of the sulfate and the fluorosulfonate ions in the electrolyte solution for a lithium secondary battery is (0.05-0.37):1. For example, the ratio of the molar amount of the positive electrode film-forming additive to the sum of the molar amounts of the sulfate and the fluorosulfonate ions may be (0.05-0.36):1, (0.08-0.35):1, (0.1-0.33):1, (0.12-0.3):1, (0.15-0.29):1, (0.13-0.25):1, (0.15-0.22):1, (0.17-0.2):1, etc. In this way, the ratio of the molar amount of the positive electrode film-forming additive in the electrolyte solution for a lithium secondary battery to the sum of the molar amounts of the sulfate and the fluosulfonate ions is within the above range, thus not only reducing the impact on the functioning of the sulfate and the fluosulfonate ions since the amount of the positive electrode film-forming additive is too large and preventing the DC impedance of the secondary battery from increasing, but also reducing the inability of the positive electrode film-forming additive to play a role in the formation of the positive electrode interface film since the amount of the positive electrode film-forming additive is too small, reducing the DC internal resistance of the secondary battery, and improving the storage performance and cycling performance of the secondary battery. In some other embodiments of the present application, the ratio of the molar amount of the positive electrode film-forming additive to the sum of the molar amounts of the sulfate and the fluorosulfonate ions in the electrolyte solution for a lithium secondary battery is (0.06-0.3):1.

In some embodiments of the present application, the molar concentration of the positive electrode film-forming additive in the electrolyte solution for a lithium secondary battery is 0.01 mol/L-0.03 mol/L. For example, the molar concentration of the positive electrode film-forming additive in the electrolyte solution for a lithium secondary battery may be 0.01 mol/L-0.025 mol/L, 0.013 mol/L-0.024 mol/L, 0.015 mol/L-0.023 mol/L, 0.018 mol/L-0.02 mol/L, etc. In this way, the concentration of the positive electrode film-forming additive in the electrolyte solution for a lithium secondary battery is within the above range, thus not only reducing the increase of the DC impedance of the secondary battery since the amount of the positive electrode film-forming additive is too large, but also reducing the inability of the positive electrode film-forming additive to play a role in the formation of the positive electrode interface film since the amount of the positive electrode film-forming additive is too small, reducing the DC internal resistance of the secondary battery, and improving the storage performance and cycling performance of the secondary battery.

In some embodiments of the present application, the electrolyte solution for a lithium secondary battery further includes difluorophosphate ions. In this way, the difluorophosphate ions can change the solvation structure of the electrolyte solution for a lithium secondary battery, so that more alkali metal ions can participate in the film formation, thus improving the ionic conductivity of the interface film, and improving the transmission resistance of alkali metal ions; in addition, the difluorophosphate ions can also participate in the formation of the positive and negative electrode interface film, thus improving the thermal stability of the interface film, and improving the storage performance of the secondary battery while reducing the DC impedance of the secondary battery.

In some embodiments of the present application, the ratio of the molar amount of the difluorophosphate ions to the sum of the molar amounts of the sulfate and the fluorosulfonate ions in the electrolyte solution for a lithium secondary battery is (0.048-1):1. For example, the ratio of the molar amount of the difluorophosphate ions to the sum of the molar amounts of the sulfate and the fluorosulfonate ions in the electrolyte solution for a lithium secondary battery may be (0.048-0.95):1, (0.05-0.9):1, (0.1-0.8):1, (0.2-0.7):1, (0.3-0.6):1, (0.4-0.5):1, etc. Specifically, the ratio of the molar amount of the difluorophosphate ions to the sum of the molar amounts of the sulfate and the fluosulfonate ions in the electrolyte solution for a lithium secondary battery is within the above range, thus changing the solvation structure of the electrolyte solution for a lithium secondary battery, so that more alkali metal ions can participate in the film formation, improving the ionic conductivity of the interface film, and improving the transmission resistance of alkali metal ions; in addition, the difluorophosphate ions can also participate in the formation of the positive and negative interface film, thus improving the thermal stability of the interface film, and improving the storage performance of the secondary battery while reducing the DC impedance of the secondary battery. In some other embodiments of the present application, the ratio of the molar amount of the difluorophosphate ions to the sum of the molar amounts of the sulfate and the fluorosulfonate ions in the electrolyte solution for a lithium secondary battery is (0.13-0.58):1.

In some embodiments of the present application, the molar concentration of the difluorophosphate ions in the electrolyte solution for a lithium secondary battery is 0.01 mol/L-0.08 mol/L. For example, the molar concentration of the difluorophosphate ions in the electrolyte solution for a lithium secondary battery is 0.01 mol/L-0.07 mol/L, 0.02 mol/L-0.06 mol/L, 0.03 mol/L-0.05 mol/L, 0.04 mol/L-0.05 mol/L, etc. Specifically, the molar concentration of the difluorophosphate ions in the electrolyte solution for a lithium secondary battery is within the above range, thus not only reducing the impact on the functioning of the fluorosulfonate ions and sulfate since the amount of the added difluorophosphate ions is too large, but also allowing the difluorophosphate ions to function effectively, reducing the DC internal resistance of the secondary battery, and improving the storage performance and cycling performance of the secondary battery. In some other embodiments of the present application, the molar concentration of the difluorophosphate ions in the electrolyte solution for a lithium secondary battery is 0.02 mol/L-0.06 mol/L.

In some embodiments of the present application, the difluorophosphate ions are MPO₂F₂, where M includes at least one of Li, Na, K, and H. Specifically, the substance containing the difluorophosphate ions can provide the difluorophosphate ions and change the solvation structure of the electrolyte solution for a lithium secondary battery, so that more alkali metal ions can participate in the film formation, thus improving the ionic conductivity of the interface film, and improving the transmission resistance of alkali metal ions; in addition, the difluorophosphate ions can also participate in the formation of the positive and negative electrode interface film, thus improving the thermal stability of the interface film, and improving the storage performance of the secondary battery while reducing the DC impedance of the secondary battery.

In some embodiments of the present application, the electrolyte solution for a lithium secondary battery further includes tetrafluoroborate ions. The tetrafluoroborate ions are compatible with the electrolyte solution system for the lithium secondary battery and can participate in the formation of the negative electrode interface film of the secondary battery, thus opening the ion channel, and reducing the DC internal resistance of the secondary battery.

In some embodiments of the present application, a substance containing the tetrafluoroborate ions may be at least one of tetrafluoroboric acid, sodium tetrafluoroborate, potassium tetrafluoroborate, and lithium tetrafluoroborate.

In some embodiments of the present application, the ratio of the molar amount of the tetrafluoroborate ions to the sum of the molar amounts of the sulfate and the fluorosulfonate ions in the electrolyte solution for a lithium secondary battery is (0.0024-0.012):1. For example, the ratio of the molar amount of the fluorosulfonate ions to the sum of the molar amounts of the sulfate and the fluorosulfonate ions may be (0.0024-0.011):1, (0.003-0.01):1, (0.004-0.009):1, (0.005-0.008):1, (0.006-0.007):1, etc. In this way, the ratio of the molar amount of the tetrafluoroborate ions in the electrolyte solution for a lithium secondary battery to the sum of the molar amounts of the sulfate and the fluosulfonate ions is within the above range, thus not only reducing the impact on the functioning of the sulfate and the fluosulfonate ions since the amount of the tetrafluoroborate ions is too large and preventing the DC impedance of the secondary battery from increasing, but also reducing the inability of the tetrafluoroborate ions to play a role in the formation of the negative electrode interface film since the amount of the tetrafluoroborate ions is too small, reducing the DC internal resistance of the secondary battery, and improving the storage performance and cycling performance of the secondary battery. In some other embodiments of the present application, the ratio of the molar amount of the tetrafluoroborate ions to the sum of the molar amounts of the sulfate and the fluorosulfonate ions in the electrolyte solution for a lithium secondary battery is (0.0038-0.008):1.

In some embodiments of the present application, the molar concentration of the tetrafluoroborate ions in the electrolyte solution for a lithium secondary battery is 0.0005 mol/L-0.001 mol/L. For example, the molar concentration of the tetrafluoroborate ions in the electrolyte solution for a lithium secondary battery may be 0.0005 mol/L-0.0009 mol/L, 0.0006 mol/L-0.0008 mol/L, 0.0007 mol/L-0.0008 mol/L, etc. In this way, the molar concentration of the tetrafluoroborate ions in the electrolyte solution for a lithium secondary battery is within the above range, thus reducing the deterioration of the DC impedance of the secondary battery since the amount of the tetrafluoroborate ions is too large, allowing the tetrafluoroborate ions to play a role in forming the negative electrode interface film, reducing the DC internal resistance of the secondary battery, and improving the storage performance and cycling performance of the secondary battery. In some other embodiments of the present application, the molar concentration of the tetrafluoroborate ions in the electrolyte solution for a lithium secondary battery is 0.0006 mol/L-0.0008 mol/L.

In some embodiments of the present application, the content of water in the electrolyte solution for a lithium secondary battery is less than or equal to 20 ppm. For example, the content of water in the electrolyte solution for a lithium secondary battery may be 1 ppm-19 ppm, 2 ppm-18 ppm, 3 ppm-17 ppm, 4 ppm-16 ppm, 5 ppm-15 ppm, 6 ppm-14 ppm, 7 ppm-13 ppm, 8 ppm-12 ppm, 9 ppm-11 ppm, etc. In this way, the content of water in the electrolyte solution for a lithium secondary battery is within the above range, thus reducing the damage caused by water to the interface film of the secondary battery especially at high voltage, reducing the DC internal resistance of the secondary battery, and improving the storage performance and cycling performance of the secondary battery.

In some embodiments of the present application, the content of HF in the electrolyte solution for a lithium secondary battery is less than or equal to 150 ppm. For example, the content of HF in the electrolyte solution for a lithium secondary battery may be 10 ppm-140 ppm, 20 ppm-130 ppm, 30 ppm-120 ppm, 40 ppm-110 ppm, 50 ppm-100 ppm, 60 ppm-90 ppm, 70 ppm-80 ppm, etc. In this way, the content of HF in the electrolyte solution for a lithium secondary battery is within the above range, thus reducing the damage caused by HF to the interface film of the secondary battery especially at high voltage, reducing the DC interface resistance of the secondary battery, and improving the storage performance and cycling performance of the secondary battery.

It is to be understood that the control of water and HF in the electrolyte solution for a lithium secondary battery can be controlled by using molecular sieves to remove water and HF. Specifically, molecular sieves may be added to the electrolyte solution for a lithium secondary battery, the molecular sieves are enabled to fully contact with the electrolyte solution for a lithium secondary battery to adsorb water and HF in the electrolyte solution for a lithium secondary battery, and then the molecular sieves are separated from the electrolyte solution for a lithium secondary battery through a method such as filtration or centrifugation.

It is to be understood that the content of water and HF in the electrolyte solution for a lithium secondary battery can be measured through the following method:

Testing of content of water: an electrolyte solution for a lithium secondary battery is injected into an electrolytic cell that has reached a balance. After an indicator electrode detects H₂O, an electrode oxidizes I⁻ to I₂, and I₂ and H₂O undergo a quantitative chemical reaction, thus calculating the content of water; according to 5.9 Determination of Water in HG/T4067-2015 Hexafluorophosphate Electrolyte Solution; a quantitative reaction equation for I₂ and H₂O: H₂O+I₂+SO₂+3C₅H₅N=2C₅H₅N·HI+C₅H₅N·SO₃; the amount of water is calculated based on the amount of consumed iodine.

Testing of content of hydrofluoric acid: in a dry environment, free acid in the electrolyte solution is titrated with a triethylamine standard solution, and the content of HF is calculated;
5.10 Determination of Content of Free Acid in HG/T4067-2015 Lithium Hexafluorophosphate Electrolyte Solution;

$$HF ( ppm ) = ( V 2 - V 1 ) / 1000 * C * 20 / m * 1000000 = ( V 2 - V 1 ) * C / m * 20000 ;$$

where 0.01 is the concentration of a standard solution, 0.02 mol/L;
V1 is the volume reading of a burette before titration, ml;
V2 is the volume reading of the burette after an electrolyte solution sample is added and the titration terminates, ml;
20 is the molecular weight of HF, g/mol;
m is the amount of the weighed electrolyte solution, g;
20000 is the coefficient for conversion into ug/g.

In some embodiments of the present application, the electrolyte solution for a lithium secondary battery may further include an electrolyte salt and a solvent.

When the secondary battery is a lithium ion battery, as an example, the electrolyte salt may include, but not limited to, at least one of lithium hexafluorophosphate (LiPF₆), lithium tetrafluoroborate (LiBF₄), lithium perchlorate (LiClO₄), lithium hexafluoroarsenate (LiAsF₆), lithium bis(fluorosulfonyl)imide (LiFSI), lithium bis(trifluoromethanesulfonyl)imide (LiTFSI), lithium trifluoromethanesulfonate (LiTFS), lithium difluoro(oxalato)borate (LiDFOB), lithium bis(oxalate)borate (LiBOB), lithium difluorophosphate (LiPO₂F₂), lithium difluoro bis(oxalato)phosphate (LiDFOP), and lithium tetrafluoro(oxalato)phosphate (LiTFOP).

As an example, the solvent may include, but not limited to, at least one of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1, 4-butyrolactone (GBL), sulfolane (SF), methylsulfonylmethane (MSM), ethyl methyl sulfone (EMS), and ethylsulfonylethane (ESE).

In some embodiments, the electrolyte solution for a lithium secondary battery may further include an additive. For example, the additive may include an additive capable of improving certain performances of the secondary battery, such as an additive for improving the overcharging performance of the secondary battery, an additive for improving the high-temperature performance of the secondary battery, and an additive for improving the low-temperature performance of the secondary battery.

According to a second aspect, the present application provides a secondary battery, which includes the electrolyte solution for a lithium secondary battery according to the first aspect of the present application. In this way, the secondary battery has low DC internal resistance and excellent storage performance and cycling performance.

The secondary battery refers to a battery that can be used continually by activating an active material in a charging manner after being discharged.

Generally, the secondary battery includes a positive electrode plate, a negative electrode plate, a separator and an electrolyte. During charging and discharging of the secondary battery, active ions (alkali metal ions) are intercalated and deintercalated back and forth between the positive electrode plate and the negative electrode plate. The separator is arranged between the positive electrode plate and the negative electrode plate, to serve for separation. The electrolyte plays the role of conducting ions between the positive electrode plate and the negative electrode plate.

In some embodiments of the present application, the secondary battery may be a lithium-ion battery.

### [Positive Electrode Plate]

In a secondary battery, the positive electrode plate generally includes a positive electrode current collector and a positive electrode active material layer arranged on the positive electrode current collector, and the positive electrode active material layer includes a positive electrode active material.

The positive electrode current collector may be a conventional metal foil or a composite current collector (a metal material may be arranged on a polymer substrate to form a composite current collector). As an example, the positive electrode current collector may use aluminum foil.

The specific type of the positive electrode active material is not limited. Any material that can be used as the positive electrode active material of the secondary battery known in the art may be used, and may be selected by those skilled in the art according to the actual need.

For example, in a case that the secondary battery is a lithium-ion battery, as an example, the positive electrode active material may include, but not limited to, at least one of a lithium transition metal oxide, a lithium-containing phosphate with an olivine structure, and respective modified compounds thereof. Examples of the lithium transition metal oxide can include, but are not limited to, at least one of lithium-cobalt oxide, lithium-nickel oxide, lithium-manganese oxide, lithium-nickel-cobalt oxide, lithium-manganese-cobalt oxide, lithium-nickel-manganese oxide, lithium-nickel-cobalt-manganese oxide, lithium-nickel-cobalt-aluminum oxide, and modified compounds thereof. Examples of the lithium-containing phosphate with an olivine structure can include, but are not limited to, at least one of lithium iron phosphate, a composite material of lithium iron phosphate and carbon, lithium manganese phosphate, a composite material of lithium manganese phosphate and carbon, lithium iron manganese phosphate, and a composite material of lithium iron manganese phosphate and carbon, and modified compounds thereof. These materials are all commercially available.

In some embodiments of the present application, the positive electrode active material includes LiₓNi_{(1-y-z)}Co_{y}M_{z}O_{2-b}, where M includes at least one of Mn, Al, Fe, Ti, Mg, Cr, Ga, Cu, Zn, Nb, and Zr, 0<x≤1.2, 0.05≤y≤0.8, 0.01≤z≤0.5, and 0≤b≤0.2.

For example, x may satisfy: 0.2≤x≤1.2, 0.4≤x≤1.1, 0.5≤x≤1.0, 0.6≤x≤0.9, 0.7≤x≤0.8, etc; y may satisfy: 0.05≤y≤0.7, 0.1≤y≤0.6, 0.2≤y≤0.5, 0.3≤y≤0.4, etc; z may satisfy: 0.01≤z≤0.45, 0.1≤z≤0.4, 0.2≤z≤0.3, etc; b may satisfy: 0≤b≤0.15, 0.02≤b≤0.13, 0.05≤b≤0.1, 0.07≤b≤0.09, etc.

It needs be noted that in the positive electrode plate, the secondary battery, or the electrical device, due to processes such as formation and cycling of the secondary battery, lithium ions will be consumed, so that the measured lithium element content x in the positive electrode active material will be less than 1. At the same time, if a lithium supplements is used for the positive electrode plate and the negative electrode plate, after the secondary battery undergoes processes such as formation and cycling, the measured lithium element content x in the positive electrode active material will be greater than 1.

In addition, due to processes such as formation and cycling of the secondary battery, lattice oxygen release may occur in the positive electrode active material, resulting in oxygen loss. Therefore, the oxygen element content in the positive electrode active material may be less than 2.

In some embodiments of the present application, the BET specific surface area of the positive electrode active material is less than or equal to 3 m²/g. For example, the BET specific surface area of the positive electrode active material may be 0.3 m²/g-3 m²/g, 1 m²/g-2.5 m²/g, 1.2 m²/g-2.3 m²/g, 1.5 m²/g-2 m²/g, etc. Specifically, the BET specific surface area of the positive electrode active material is within the above range, thus reducing the side reaction of the positive electrode active material under high voltage, and improving the storage and cycling performance of the secondary battery. In some other embodiments of the present application, the BET specific surface area of the positive electrode active material is 1 m²/g-2.5 m²/g.

It is to be understood that the BET specific surface area of the positive electrode active material may be measured by using the following method: a GeminiVII2390 multi-station fully automatic BET specific surface area and porosity analyzer from Micromeritics, USA, is used, about 7 g of a sample were taken and placed in a 9 cc long tube with a bulb, degassing was performed at 200° C. for 2 h, and then it is placed in a main machine for testing to obtain the BET (specific surface area) data of the positive electrode active material.

The positive electrode active material layer generally further optionally includes a binder, a conductive agent, and other optional adjuvants.

By way of example, the conductive agent can include at least one of superconducting carbon, acetylene black, carbon black, Ketjen black, carbon dots, carbon nanotubes, Super P (SP), graphene, and carbon nanofibers.

As an example, the binder may include at least one of styrene butadiene rubber (SBR), water-based acrylic resin, polyvinylidene fluoride (PVDF), polytetrafluoroethylene (PTFE), ethylene-vinyl acetate copolymer (EVA), polyacrylic acid (PAA), carboxymethyl cellulose (CMC), polyvinyl alcohol (PVA), and polyvinyl butyral (PVB).

### [Negative Electrode Plate]

In a secondary battery, the negative electrode plate typically includes a negative electrode current collector and a negative electrode active material layer arranged on the negative electrode current collector, and the negative electrode active material layer includes a negative electrode active material.

The negative electrode current collector may be at conventional metal foil or a composite current collector (for example, a metal material may be arranged on a polymer substrate to form a composite current collector). As an example, the negative electrode current collector may be a copper foil.

The specific type of the negative electrode active material is not limited. Any material that can be used as the negative electrode active material of the secondary battery as known in the art may be used, and may be selected by those skilled in the art according to the actual need. As an example, the negative electrode active material may include, but not limited to, at least one of artificial graphite, natural graphite, hard carbon, soft carbon, a silicon-based material, and a tin-based material. The silicon-based material may include at least one of elemental silicon, a silicon-oxygen compound (such as silicon monoxide), a silicon-carbon compound, a silicon-nitrogen compound, and a silicon alloy. The tin-based material may include at least one of elemental tin, a tin-oxygen compound, and a tin alloy. These materials are all commercially available.

In some implementations, in order to further improve the energy density of the secondary battery, the negative electrode active material may include a silicon-based material.

The negative electrode active material layer generally further optionally includes a binder, a conductive agent, and other optional adjuvants.

As example, the conductive agent may include at least one of superconducting carbon, acetylene black, carbon black, Ketjen black, carbon dots, carbon nanotubes, graphene, and carbon nanofibers.

As an example, the binder may include, but not limited to, at least one of polymerized styrene butadiene rubber (SBR), water-based acrylic resin, polyvinylidene fluoride (PVDF), polytetrafluoroethylene (PTFE), ethylene-vinyl acetate copolymer (EVA), polyvinyl alcohol (PVA), and polyvinyl butyral (PVB).

As an example, other optional adjuvants may include a thickener and dispersant (for example, carboxymethylcellulose sodium (CMC-Na)) or PTC thermistor material.

The above separator film is not particularly limited in the present application, and any well-known separator film having a porous structure with electrochemical stability and mechanical stability can be selected according to actual needs, for example, it can include a single-layer or multi-layer thin film including at least one of glass fibers, non-woven fabric, polyethylene, polypropylene, and polyvinylidene fluoride.

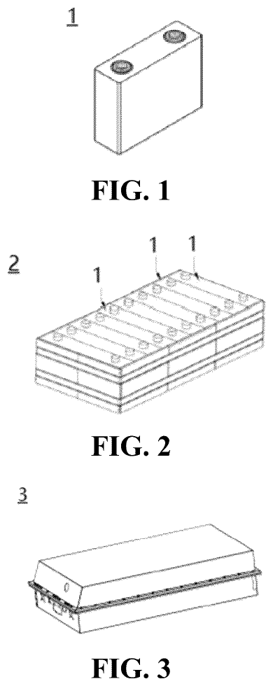

The shape of the secondary battery is not specially limited in this embodiment of the present application, which may be a cylindrical shape, a square shape, or any other shape. FIG. 1 shows a secondary battery 1 having a square structure as an example.

In some embodiments, the secondary battery may include an outer package. The outer package may be used for encapsulating the positive electrode plate, the negative electrode plate, and the electrolyte.

In some embodiments, the outer package may include a case and a cover plate. The case may include a bottom plate and a side plate connected to the bottom plate, which enclose to form an accommodating cavity. The case has an opening in communication with the accommodating cavity, and the cover plate can cover the opening to close the accommodating cavity.

The positive electrode plate, the negative electrode plate, and the separator film can be made into an electrode assembly by a winding process or a lamination process. The electrode assembly is encapsulated into the accommodating cavity. The number of electrode assemblies contained in the secondary battery may be one or more, and may be adjusted according to requirements.

In some embodiments, the outer package of the secondary battery may be a hard case, such as a hard plastic case, an aluminum case, or a steel case.

The outer package of the secondary battery may also be a soft package, such as a bag-type soft package. The material of the soft package can be plastic, and for example may include at least one of polypropylene (PP), polybutylene terephthalate (PBT), and polybutylene succinate (PBS).

In some embodiments, secondary batteries may be assembled into a battery module, multiple secondary batteries may be contained in the battery module, and the specific number of secondary batteries can be adjusted according to the application and capacity of the battery module.

FIG. 2 shows a battery module 2 as an example. Referring to FIG. 2, in the battery module 2, multiple secondary batteries 1 may be sequentially arranged along a length direction of the battery module 2. Of course, they may be arranged in any other way. The multiple secondary batteries 1 can be further fixed by fasteners.

The battery module 2 may further include a shell with an accommodating space. The multiple secondary batteries 1 are accommodated in the accommodating space. In some embodiments, the battery modules may further be assembled into a battery pack, and the number of battery modules contained in the battery pack may be adjusted according to the application and capacity of the battery pack.

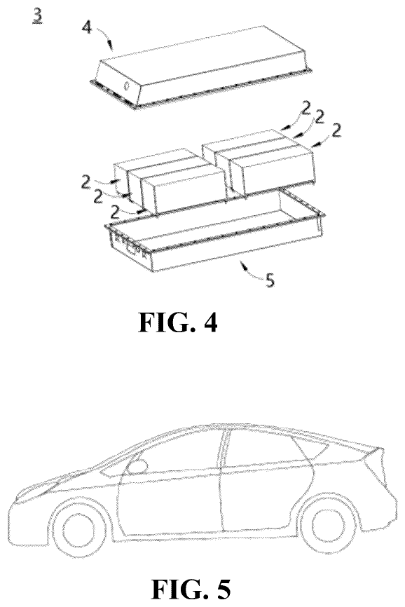

FIG. 3 and FIG. 4 show a battery pack 3 as an example. Referring to FIG. 3 and FIG. 4, the battery pack 3 may include a battery box and multiple battery modules 2 arranged in the battery box. The battery box includes an upper box 4 and a lower box 5. The upper box 4 can cover the lower box 5 to form an enclosed space for accommodating the battery module 2. The multiple battery modules 2 may be arranged in the battery box in any manner.

According to a third aspect, the present application provides an electrical device, which includes the secondary battery according to the second aspect. Specifically, the secondary battery may be used as a power source for the electrical device or an energy storage unit for the electrical device. The electrical device may include, but not limited to, a mobile apparatus (for example, a mobile phone or a laptop), an electric vehicle (for example, an all-electric vehicle, a hybrid electric vehicle, a plug-in hybrid electric vehicle, an electric bicycle, an electric scooter, an electric golf cart, or an electric truck), an electric train, a ship, a satellite, and an energy storage system.

FIG. 5 is an electrical device as an example. The electrical device includes an all-electric vehicle, a hybrid electric vehicle, or a plug-in hybrid electric vehicle.

As another example, the electrical device may include a mobile phone, a tablet, and a laptop. The electrical device is generally required to be light and thin and may use a secondary battery as a power source.

In order to make the technical problems addressed by, the technical solutions, and the beneficial effects of the embodiments of the present application clearer, the following will further describe them in detail in conjunction with the embodiments and the accompanying drawings. It is clear that the described embodiments are only some, rather than all, of the embodiments of the present application. The following description of at least one exemplary embodiment is actually merely illustrative and by no means constitutes any limitation on the present application and the use thereof. All other embodiments obtained by those of ordinary skill in the art based on the embodiments of the present application without involving any creative effort shall fall within the scope of protection of the present application.

### Example 1

### Preparation of Secondary Battery Containing Electrolyte Solution for Lithium Secondary Battery

### 1. Preparation of Electrolyte Solution for Lithium Secondary Battery

Ethylene carbonate (EC) and ethyl methyl carbonate (EMC) were mixed according to a mass ratio of 30:70 to obtain an organic solvent, and fully dried electrolyte salt LiPF₆, a sulfate, lithium fluorosulfonate, and a positive electrode film-forming additive, lithium difluorophosphate, and lithium tetrafluoroborate were dissolved in the solvent, and uniform mixing was performed to obtain an electrolyte solution for a lithium secondary battery.

Molecular sieves were added to the electrolyte solution for a lithium secondary battery, the molecular sieves were enabled to fully contact with the electrolyte solution for a lithium secondary battery to adsorb water and HF in the electrolyte solution for a lithium secondary battery, and then the molecular sieves were separated from the electrolyte solution for a lithium secondary battery through a method such as filtration to remove water and HF in the electrolyte solution for a lithium secondary battery.

### 2. Preparation of Secondary Battery

### Preparation of Positive Electrode Plate

A positive electrode active material LiNi_{0.8}Co_{0.1}Mn_{0.1}O₂ (NCM811), a conductive agent carbon black (Super P), and a binder polyvinylidene fluoride (PVDF) were uniformly mixed in a suitable amount of solvent N-Methylpyrrolidone (NMP) according to a mass ratio of 96.2:2.7:1.1 to obtain a positive electrode slurry, the positive electrode slurry was coated onto a positive electrode current collector aluminum foil, and then drying, cold pressing, slitting and cutting processes were performed to obtain a positive electrode plate.

### Preparation of Negative Electrode Plate

A negative electrode active material artificial graphite, a conductive agent carbon black (Super P), a binder polymerized styrene butadiene rubber (SBR), and carboxymethyl cellulose sodium (CMC-Na) were uniformly mixed in a suitable amount of solvent deionized water according to a mass ratio of 96.4:0.7:1.8:1.1 to obtain a negative electrode slurry, the negative electrode slurry was coated onto a negative electrode current collector copper foil, and then drying, cold pressing, slitting and cutting processes were performed to obtain a negative electrode plate.

A polyethylene film was used as a separator.

The positive electrode plate, the separator, and the negative electrode plate were stacked in sequence, so that the separator was located between the positive electrode plate and the negative electrode plate to play a role of separation, and then winding was performed to obtain an electrode assembly; the electrode assembly was placed in an outer package, the electrolyte solution for a lithium secondary battery was injected into the dried secondary battery, and vacuum packaging, standing, formation, and shaping processes were performed to obtain a secondary battery.

For secondary batteries in Examples 2-49 and Comparative Examples 1-2, except for different parameters (see Table 1), others were the same as Example 1.

Components of gel polymer electrolytes in secondary batteries in Examples 1-49 and Comparative Examples 1-2 of the present application were as shown in Table 1.

TABLE 1

| | | | | | Ratio of molar | |
|---|---|---|---|---|---|---|
| | | | | | amount of | |
| | | | | | positive electrode | |
| | | | | | film-forming | |
| | | | Concentration | | additive to sum | Concentration |
| | Molar ratio | | of | Positive | of molar amounts | of positive |
| | of sulfate to | Concentration | fluosulfonate | electrode | of sulfate and | electrode |
| | fluosulfonate | of sulfate | ions | film-forming | difluorophosphate | film-forming |
| S/N | ions | (mol/L) | (mol/L) | additive | ions | additive (mol/L) |
| Example 1 | 30:1 | 0.15 | 0.005 | Fluoroethylene carbonate | 0.1:1 | 0.0155 |
| | | | | and 1,3-propanesultone | | |
| Example 2 | 222.2:1 | 0.2 | 0.0009 | Fluoroethylene carbonate | 0.077:1 | 0.0155 |
| | | | | and 1,4-propanesultone | | |
| Example 3 | 8.9:1 | 0.08 | 0.009 | Fluoroethylene carbonate | 0.17:1 | 0.0155 |
| | | | | and 1,5-propanesultone | | |
| Example 4 | 10:1 | 0.09 | 0.009 | Fluoroethylene carbonate | 0.16:1 | 0.0155 |
| | | | | and 1,6-propanesultone | | |
| Example 5 | 60:1 | 0.18 | 0.003 | Fluoroethylene carbonate | 0.08:1 | 0.0155 |
| | | | | and 1,7-propanesultone | | |
| Example 6 | 20:1 | 0.1 | 0.005 | Fluoroethylene carbonate | 0.15:1 | 0.0155 |
| | | | | and 1,8-propanesultone | | |
| Example 7 | 80:1 | 0.08 | 0.001 | Fluoroethylene carbonate | 0.19:1 | 0.0155 |
| | | | | and 1,9-propanesultone | | |
| Example 8 | 13.3:1 | 0.08 | 0.006 | Fluoroethylene carbonate | 0.18:1 | 0.0155 |
| | | | | and 1,10-propanesultone | | |
| Example 9 | 30:1 | 0.15 | 0.005 | Fluoroethylene carbonate | 0.1:1 | 0.0155 |
| Example 10 | 30:1 | 0.15 | 0.005 | 1,3-propanesultone | 0.1:1 | 0.0155 |
| Example 11 | 30:1 | 0.15 | 0.005 | / | / | / |
| Example 12 | 8:1 | 0.15 | 0.019 | / | / | / |
| Example 13 | 223:1 | 0.223 | 0.001 | / | / | / |
| Example 14 | 100:1 | 0.1 | 0.001 | / | / | / |
| Example 15 | 16.7:1 | 0.15 | 0.009 | / | / | / |
| Example 16 | 50:1 | 0.15 | 0.003 | / | / | / |
| Example 17 | 30:1 | 0.15 | 0.005 | Fluoroethylene carbonate | 0.1:1 | 0.0155 |
| | | | | and 1,3-propanesultone | | |
| Example 18 | 30:1 | 0.15 | 0.005 | Fluoroethylene carbonate | 0.37:1 | 0.057 |
| | | | | and 1,3-propanesultone | | |
| Example 19 | 30:1 | 0.15 | 0.005 | Fluoroethylene carbonate | 0.05:1 | 0.0078 |
| | | | | and 1,3-propanesultone | | |
| Example 20 | 30:1 | 0.15 | 0.005 | Fluoroethylene carbonate | 0.06:1 | 0.0093 |
| | | | | and 1,3-propanesultone | | |
| Example 21 | 30:1 | 0.15 | 0.005 | Fluoroethylene carbonate | 0.3:1 | 0.0465 |
| | | | | and 1,3-propanesultone | | |
| Example 22 | 30:1 | 0.15 | 0.005 | Fluoroethylene carbonate | / | / |
| | | | | and 1,4-propanesultone | | |
| Example 23 | 30:1 | 0.15 | 0.005 | Fluoroethylene carbonate | / | / |
| | | | | and 1,4-propanesultone | | |
| Example 24 | 30:1 | 0.15 | 0.005 | Fluoroethylene carbonate | / | / |
| | | | | and 1,4-propanesultone | | |
| Example 25 | 30:1 | 0.15 | 0.005 | Fluoroethylene carbonate | / | / |
| | | | | and 1,4-propanesultone | | |
| Example 26 | 30:1 | 0.15 | 0.005 | Fluoroethylene carbonate | / | / |
| | | | | and 1,4-propanesultone | | |
| Example 27 | 30:1 | 0.15 | 0.005 | Fluoroethylene carbonate | / | / |
| | | | | and 1,5-propanesultone | | |
| Example 28 | 30:1 | 0.15 | 0.005 | Fluoroethylene carbonate | / | / |
| | | | | and 1,5-propanesultone | | |
| Example 29 | 30:1 | 0.15 | 0.005 | Fluoroethylene carbonate | / | / |
| | | | | and 1,5-propanesultone | | |
| Example 30 | 30:1 | 0.15 | 0.005 | Fluoroethylene carbonate | / | / |
| | | | | and 1,5-propanesultone | | |
| Example 31 | 30:1 | 0.15 | 0.005 | Fluoroethylene carbonate | 0.1:1 | 0.0155 |
| | | | | and 1,5-propanesultone | | |
| Example 32 | 88.9:1 | 0.08 | 0.0009 | Fluoroethylene carbonate | 0.37:1 | 0.03 |
| | | | | and 1,6-propanesultone | | |
| Example 33 | 22.2:1 | 0.2 | 0.009 | Fluoroethylene carbonate | 0.05:1 | 0.01 |
| | | | | and 1,7-propanesultone | | |
| Example 34 | 22.2:1 | 0.2 | 0.009 | Fluoroethylene carbonate | 0.074:1 | 0.0155 |
| | | | | and 1,3-propanesultone | | |
| Example 35 | 88.9:1 | 0.08 | 0.0009 | Fluoroethylene carbonate | 0.37:1 | 0.03 |
| | | | | and 1,4-propanesultone | | |
| Example 36 | 22.2:1 | 0.2 | 0.009 | Fluoroethylene carbonate | 0.074:1 | 0.0155 |
| | | | | and 1,3-propanesultone | | |
| Example 37 | 22.2:1 | 0.2 | 0.009 | Fluoroethylene carbonate | 0.074:1 | 0.0155 |
| | | | | and 1,3-propanesultone | | |
| Example 38 | 80:1 | 0.08 | 0.001 | Fluoroethylene carbonate | 0.19:1 | 0.0155 |
| | | | | and 1,9-propanesultone | | |
| Example 39 | 80:1 | 0.08 | 0.001 | Fluoroethylene carbonate | 0.19:1 | 0.0155 |
| | | | | and 1,9-propanesultone | | |
| Example 40 | 80:1 | 0.08 | 0.001 | Fluoroethylene carbonate | 0.19:1 | 0.0155 |
| | | | | and 1,9-propanesultone | | |
| Example 41 | 80:1 | 0.08 | 0.001 | Fluoroethylene carbonate | 0.19:1 | 0.0155 |
| | | | | and 1,9-propanesultone | | |
| Example 42 | 30:1 | 0.15 | 0.005 | Fluoroethylene carbonate | 0.1:1 | 0.0155 |
| | | | | and 1,3-propanesultone | | |
| Example 43 | 30:1 | 0.15 | 0.005 | Fluoroethylene carbonate | 0.1:1 | 0.0155 |
| | | | | and 1,3-propanesultone | | |
| Example 44 | 30:1 | 0.15 | 0.005 | Fluoroethylene carbonate | 0.1:1 | 0.0155 |
| | | | | and 1,3-propanesultone | | |
| Example45 | 30:1 | 0.15 | 0.005 | Fluoroethylene carbonate | 0.1:1 | 0.0155 |
| | | | | and 1,3-propanesultone | | |
| Example 46 | 30:1 | 0.15 | 0.005 | Fluoroethylene carbonate | 0.1:1 | 0.0155 |
| | | | | and 1,3-propanesultone | | |
| Example 47 | 30:1 | 0.15 | 0.005 | Fluoroethylene carbonate | 0.1:1 | 0.0155 |
| | | | | and 1,3-propanesultone | | |
| Example 48 | 30:1 | 0.15 | 0.005 | Fluoroethylene carbonate | 0.1:1 | 0.0155 |
| | | | | and 1,3-propanesultone | | |
| Example 49 | 30:1 | 0.15 | 0.005 | Fluoroethylene carbonate | 0.1:1 | 0.0155 |
| | | | | and 1,3-propanesultone | | |
| Comparative | 5:1 | 0.08 | 0.016 | Fluoroethylene carbonate | 0.16:1 | 0.0155 |
| Example 1 | | | | and 1,3-propanesultone | | |
| Comparative | 230:1 | 0.207 | 0.0009 | Fluoroethylene carbonate | 0.075:1 | 0.0155 |
| Example 2 | | | | and 1,4-propanesultone | | |

| | Ratio of molar | | | Ratio of molar | | BET |
|---|---|---|---|---|---|---|
| | amount of | | | amount of | | specific |
| | difluorophosphate | | | tetrafluoroborate | | surface |
| | ions to sum of | | | ions to sum of | | area of |
| | molar amounts | Concentration of | Concentration of | molar amounts | Positive | positive |
| | of sulfate and | difluorophosphate | tetrafluoroborate | of sulfate and | electrode | electrode |
| | fluorosulfonate | ions | ions | difluorophosphate | active | plate |
| S/N | ions | (mol/L) | (mol/L) | ions | material | (m²/g) |
| Example 1 | 0.26:1 | 0.04 | 0.0007 | 0.0045:1 | LiNi_{0.4}Co_{0.4}Mn_{0.2}O₂ | 2 |
| Example 2 | 0.2:1 | 0.04 | 0.0007 | 0.003:1 | LiNi_{0.4}Co_{0.4}Mn_{0.2}O₂ | 2 |
| Example 3 | 0.45:1 | 0.04 | 0.0007 | 0.008:1 | LiNi_{0.4}Co_{0.4}Mn_{0.2}O₂ | 2 |
| Example 4 | 0.4:1 | 0.04 | 0.0007 | 0.007:1 | LiNi_{0.4}Co_{0.4}Mn_{0.2}O₂ | 2 |
| Example 5 | 0.22:1 | 0.04 | 0.0007 | 0.004:1 | LiNi_{0.4}Co_{0.4}Mn_{0.2}O₂ | 2 |
| Example 6 | 0.38:1 | 0.04 | 0.0007 | 0.007:1 | LiNi_{0.4}Co_{0.4}Mn_{0.2}O₂ | 2 |
| Example 7 | 0.49:1 | 0.04 | 0.0007 | 0.0086:1 | LiNi_{0.4}Co_{0.4}Mn_{0.2}O₂ | 2 |
| Example 8 | 0.47:1 | 0.04 | 0.0007 | 0.0081:1 | LiNi_{0.4}Co_{0.4}Mn_{0.2}O₂ | 2 |
| Example 9 | 0.26:1 | 0.04 | 0.0007 | 0.0045:1 | LiNi_{0.4}Co_{0.4}Mn_{0.2}O₂ | 2 |
| Example 10 | 0.26:1 | 0.04 | 0.0007 | 0.0045:1 | LiNi_{0.4}Co_{0.4}Mn_{0.2}O₂ | 2 |
| Example 11 | / | / | / | / | LiNi_{0.4}Co_{0.4}Mn_{0.2}O₂ | 2 |
| Example 12 | / | / | / | / | LiNi_{0.4}Co_{0.4}Mn_{0.2}O₂ | 2 |
| Example 13 | / | / | / | / | LiNi_{0.4}Co_{0.4}Mn_{0.2}O₂ | 2 |
| Example 14 | / | / | / | / | LiNi_{0.4}Co_{0.4}Mn_{0.2}O₂ | 2 |
| Example 15 | / | / | / | / | LiNi_{0.4}Co_{0.4}Mn_{0.2}O₂ | 2 |
| Example 16 | / | / | / | / | LiNi_{0.4}Co_{0.4}Mn_{0.2}O₂ | 2 |
| Example 17 | / | / | / | / | LiNi_{0.4}Co_{0.4}Mn_{0.2}O₂ | 2 |
| Example 18 | / | / | / | / | LiNi_{0.4}Co_{0.4}Mn_{0.2}O₂ | 2 |
| Example 19 | / | / | / | / | LiNi_{0.4}Co_{0.4}Mn_{0.2}O₂ | 2 |
| Example 20 | / | / | / | / | LiNi_{0.4}Co_{0.4}Mn_{0.2}O₂ | 2 |
| Example 21 | / | / | / | / | LiNi_{0.4}Co_{0.4}Mn_{0.2}O₂ | 2 |
| Example 22 | 0.26:1 | 0.04 | / | / | LiNi_{0.4}Co_{0.4}Mn_{0.2}O₂ | 2 |
| Example 23 | 0.048:1 | 0.0074 | / | / | LiNi_{0.4}Co_{0.4}Mn_{0.2}O₂ | 2 |
| Example 24 | 1:1 | 0.155 | / | / | LiNi_{0.4}Co_{0.4}Mn_{0.2}O₂ | 2 |
| Example 25 | 0.58:1 | 0.0899 | / | / | LiNi_{0.4}Co_{0.4}Mn_{0.2}O₂ | 2 |
| Example 26 | 0.13:1 | 0.0202 | / | / | LiNi_{0.4}Co_{0.4}Mn_{0.2}O₂ | 2 |
| Example 27 | / | / | 0.0007 | 0.0045:1 | LiNi_{0.4}Co_{0.4}Mn_{0.2}O₂ | 2 |
| Example 28 | / | / | 0.0006 | 0.0038:1 | LiNi_{0.4}Co_{0.4}Mn_{0.2}O₂ | 2 |
| Example 29 | / | / | 0.0019 | 0.012:1 | LiNi_{0.4}Co_{0.4}Mn_{0.2}O₂ | 2 |
| Example 30 | / | / | 0.0012 | 0.008:1 | LiNi_{0.4}Co_{0.4}Mn_{0.2}O₂ | 2 |
| Example 31 | 0.26:1 | 0.04 | / | / | LiNi_{0.4}Co_{0.4}Mn_{0.2}O₂ | 2 |
| Example 32 | 0.49:1 | 0.04 | 0.0007 | 0.0087:1 | LiNi_{0.4}Co_{0.4}Mn_{0.2}O₂ | 2 |
| Example 33 | 0.19:1 | 0.04 | 0.0007 | 0.0033:1 | LiNi_{0.4}Co_{0.4}Mn_{0.2}O₂ | 2 |
| Example 34 | 0.048:1 | 0.01 | 0.0007 | 0.003:1 | LiNi_{0.4}Co_{0.4}Mn_{0.2}O₂ | 2 |
| Example 35 | 0.99:1 | 0.08 | 0.0007 | 0.0087:1 | LiNi_{0.4}Co_{0.4}Mn_{0.2}O₂ | 2 |
| Example 36 | 0.095:1 | 0.02 | 0.0007 | 0.003:1 | LiNi_{0.4}Co_{0.4}Mn_{0.2}O₂ | 2 |
| Example 37 | 0.29:1 | 0.06 | 0.0007 | 0.003:1 | LiNi_{0.4}Co_{0.4}Mn_{0.2}O₂ | 2 |
| Example 38 | 0.49:1 | 0.04 | 0.001 | 0.012:1 | LiNi_{0.4}Co_{0.4}Mn_{0.2}O₂ | 2 |
| Example 39 | 0.49:1 | 0.04 | 0.0006 | 0.007:1 | LiNi_{0.4}Co_{0.4}Mn_{0.2}O₂ | 2 |
| Example 40 | 0.49:1 | 0.04 | 0.0005 | 0.006:1 | LiNi_{0.4}Co_{0.4}Mn_{0.2}O₂ | 2 |
| Example 41 | 0.49:1 | 0.04 | 0.0008 | 0.01:1 | LiNi_{0.4}Co_{0.4}Mn_{0.2}O₂ | 2 |
| Example 42 | 0.26:1 | 0.04 | 0.0007 | 0.0045:1 | LiNi_{0.1}Co_{0.4}Mn_{0.5}O₂ | 2 |
| Example 43 | 0.26:1 | 0.04 | 0.0007 | 0.0045:1 | LiNi_{0.19}Co_{0.8}Mn_{0.01}O₂ | 2 |
| Example 44 | 0.26:1 | 0.04 | 0.0007 | 0.0045:1 | LiNi_{0.45}Co_{0.05}Mn_{0.5}O₂ | 2 |
| Example 45 | 0.26:1 | 0.04 | 0.0007 | 0.0045:1 | LiNi_{0.4}Co_{0.4}Fe_{0.2}O₂ | 2 |
| Example 46 | 0.26:1 | 0.04 | 0.0007 | 0.0045:1 | LiNi_{0.4}Co_{0.4}Al_{0.2}O₂ | 2 |
| Example 47 | 0.26:1 | 0.04 | 0.0007 | 0.0045:1 | LiNi_{0.4}Co_{0.4}Mn_{0.2}O₂ | 1 |
| Example 48 | 0.26:1 | 0.04 | 0.0007 | 0.0045:1 | LiNi_{0.4}Co_{0.4}Mn_{0.2}O₂ | 2.5 |
| Example 49 | 0.26:1 | 0.04 | 0.0007 | 0.0045:1 | LiNi_{0.4}Co_{0.4}Mn_{0.2}O₂ | 3 |
| Comparative | 0.42:1 | 0.04 | 0.0007 | 0.007:1 | LiNi_{0.4}Co_{0.4}Mn_{0.2}O₂ | 2 |
| Example 1 | | | | | | |
| Comparative | 0.19:1 | 0.04 | 0.0007 | 0.0034:1 | LiNi_{0.4}Co_{0.4}Mn_{0.2}O₂ | 2 |
| Example 2 | | | | | | |

“/” in Table 1 indicates that the corresponding substance is not added or the added amount is 0.

### Performance Test of Secondary Battery:

### 1. Capacity and Cycling Performance Test of Secondary Battery

Taking Example 1 as an example, at 25° C., the secondary battery charged at a constant current of 0.5 C to a charging cut-off voltage of 4.2V, then charged at a constant voltage to a current of ≤0.05 C and stood for 5 min, then discharged at a constant current rate of 0.33 C to a discharging cut-off voltage of 2.8V, and stood for 5 min, and the battery capacity C₀ at this time was recorded, which was the initial capacity of the secondary battery. According to this method, the secondary battery waws charged and discharged for 200 cycles, and the discharging capacity of the secondary battery after 200 cycles was recorded as C₁, which was the capacity of the secondary battery after 200 cycles.

Cycling capacity retention rate of secondary battery=C₁/C₀*100%

The testing process for the capacity of the secondary batteries in Examples 2-49 and Comparative Examples 1-2 was the same as the above.

### 2. Direct Current Internal Resistance of Secondary Battery

Taking Example 1 as an example, the secondary battery was charged to 4.15V at a constant current of 1 C at 25° C., then charged at a constant voltage of 4.15V until the current dropped to 0.05 C, then discharged to 2.5V at a constant current of 1 C, and then stood for 5 min (stabilization time), a next cycle was performed, the voltage of the secondary battery before the discharging was stopped and the voltage of the secondary battery after the voltage of the secondary battery stabilized were recorded for each cycle, and finally the DC impedance was calculated by using the formula R=ΔU/I (where ΔU was the voltage difference, R was the DC resistance, and I was the discharging current).

Increase rate of internal resistance of secondary battery=(internal resistance of secondary battery after 200 cycles−initial internal resistance of secondary battery)/initial internal resistance of secondary battery*100%

The testing process for the DC internal resistance of the secondary batteries in Examples 2-49 and Comparative Examples 1-2 was the same as the above.

The performance test results of the secondary batteries of all examples and comparative examples were as shown in Table 2.

TABLE 2

| | | | | | Internal | |
|---|---|---|---|---|---|---|
| | Initial | Capacity of | Capacity | Initial | resistance of | |
| | capacity of | secondary | retention | internal | secondary | Increase |
| | secondary | battery after | rate of | resistance of | battery after | rate of |
| | battery | 200 cycles | secondary | secondary | 200 cycles | internal |
| S/N | (mAh/g) | (mAh/g) | battery | battery (Ω) | (Ω) | resistance |
| Example 1 | 100 | 97.7 | 97.7% | 20.5 | 22.7 | 10.7% |
| Example 2 | 100.2 | 96.3 | 96.1% | 20.8 | 23.7 | 13.9% |
| Example 3 | 100.1 | 96.1 | 96.0% | 20.9 | 24.1 | 15.3% |
| Example 4 | 100.1 | 97.1 | 97.0% | 20.3 | 22.8 | 12.3% |
| Example 5 | 100.2 | 97.3 | 97.1% | 20.4 | 22.6 | 10.8% |
| Example 6 | 100.3 | 98.6 | 98.3% | 20.1 | 21.9 | 9.0% |
| Example 7 | 100 | 96.6 | 96.6% | 20.3 | 23.1 | 13.8% |
| Example 8 | 100.2 | 97.2 | 97.00% | 20.3 | 22.7 | 11.80% |
| Example 9 | 99.9 | 97.1 | 97.2% | 20.9 | 23.5 | 12.4% |
| Example 10 | 100 | 97.1 | 97.1% | 21.3 | 24.7 | 16.0% |
| Example 11 | 99.8 | 96.5 | 96.7% | 21 | 24.3 | 15.7% |
| Example 12 | 100.1 | 96.0 | 95.9% | 22.2 | 25.6 | 15.4% |
| Example 13 | 100 | 96.0 | 96.0% | 23.1 | 26.3 | 14.0% |
| Example 14 | 99.9 | 97.5 | 97.6% | 21.4 | 23.7 | 10.8% |
| Example 15 | 100 | 96.6 | 96.6% | 21.6 | 25.0 | 15.6% |
| Example 16 | 100.2 | 96.7 | 96.5% | 21.8 | 25.2 | 15.8% |
| Example 17 | 99.7 | 96.4 | 96.7% | 21.1 | 24.4 | 15.6% |
| Example 18 | 100.1 | 96.4 | 96.3% | 22.1 | 25.6 | 15.7% |
| Example 19 | 100.2 | 96.7 | 96.5% | 22 | 25.5 | 15.8% |
| Example 20 | 100 | 96.7 | 96.7% | 21.9 | 25.3 | 15.6% |
| Example 21 | 100.1 | 96.7 | 96.6% | 22 | 25.4 | 15.5% |
| Example 22 | 99.6 | 95.9 | 96.3% | 21.3 | 24.9 | 16.9% |
| Example 23 | 100 | 96.2 | 96.2% | 21.1 | 24.7 | 17.1% |
| Example 24 | 100.1 | 96.2 | 96.1% | 21.5 | 25.2 | 17.0% |
| Example 25 | 100.1 | 96.1 | 96.0% | 21.3 | 25.0 | 17.2% |
| Example 26 | 100 | 96.1 | 96.1% | 21.6 | 25.3 | 17.0% |
| Example 27 | 99.7 | 96 | 96.3% | 21.4 | 25 | 16.8% |
| Example 28 | 100.1 | 96.4 | 96.3% | 21.2 | 24.8 | 16.8% |
| Example 29 | 100.2 | 96.3 | 96.1% | 21.3 | 24.9 | 16.9% |
| Example 30 | 100 | 96.0 | 96.0% | 21.1 | 24.6 | 16.8% |
| Example 31 | 99.6 | 96.1 | 96.5% | 21.5 | 25.1 | 16.7% |
| Example 32 | 100 | 97.7 | 97.7% | 20.4 | 22.4 | 9.8% |
| Example 33 | 100.1 | 98 | 97.9% | 20.3 | 23.1 | 13.8% |
| Example 34 | 99.8 | 96.5 | 96.7% | 21.7 | 25.8 | 18.9% |
| Example 35 | 99.9 | 96.4 | 96.5% | 21.9 | 25.9 | 18.3% |
| Example 36 | 100.1 | 98 | 97.9% | 20.6 | 22.1 | 7.3% |
| Example 37 | 99.9 | 98.1 | 98.2% | 20.4 | 22 | 7.8% |
| Example 38 | 99.9 | 96.6 | 96.7% | 20.5 | 23.4 | 14.1% |
| Example 39 | 100 | 97.6 | 97.6% | 20.4 | 22.9 | 12.3% |
| Example 40 | 99.8 | 96.9 | 97.1% | 20.4 | 23.3 | 14.2% |
| Example 41 | 100 | 97.8 | 97.8% | 20.6 | 22.6 | 9.7% |
| Example 42 | 100 | 96.5 | 96.5% | 20.6 | 23.2 | 12.6% |
| Example 43 | 100.3 | 96.1 | 95.8% | 20.7 | 23.5 | 13.5% |
| Example 44 | 99.9 | 95.6 | 95.7% | 20.5 | 23.7 | 15.6% |
| Example 45 | 100.2 | 95.8 | 95.6% | 20.9 | 23.4 | 12.0% |
| Example 46 | 100.4 | 95.9 | 95.5% | 21 | 23.3 | 11.0% |
| Example 47 | 100 | 97.8 | 97.8% | 20.6 | 22.5 | 9.2% |
| Example 48 | 100 | 97.6 | 97.6% | 20.7 | 22.9 | 10.6% |
| Example 49 | 99.9 | 96.1 | 96.2% | 20.4 | 24.1 | 18.1% |
| Comparative | 99.7 | 78.6 | 78.8% | 21.6 | 30.6 | 41.7% |
| Example 1 | | | | | | |
| Comparative | 99.9 | 80.5 | 80.6% | 21.2 | 29.3 | 38.2% |
| Example 2 | | | | | | |

From Table 2, it can be seen that in Examples 1-49 of the present application, the sulfate and the fluorosulfonate ions are added to the electrolyte solutions for the lithium secondary batteries, and the electrolyte solutions for the lithium secondary batteries include the sulfate and the fluorosulfonate ions mixed according to the above ratio, and the two are simultaneously used, thus reducing the DC internal resistance of the secondary batteries and improving the storage performance and cycling performance of the secondary batteries. Compared with Examples 1-49, the molar ratio of the sulfate to the fluorosulfonate ions in Comparative Examples 1-2 is not within the range in the present application, resulting in a significant decrease in the storage performance and cycling performance of the secondary batteries, and a significant increase in the DC internal resistance.

Finally, it should be noted that the above embodiments are only used for describing, instead of limiting, the technical solutions of the present application; although the present application is described in detail with reference to the foregoing embodiments, those skilled in the art should understand that they may modify the technical solutions described in the foregoing embodiments, or replace some or all of the technical features therein; however, these modifications or replacements do not make the essence of the corresponding technical solutions deviate from the scope of the technical solutions of the embodiments of the present application, and should be all included in the scope of the claims and description of the present application. In particular, the technical features mentioned in the various embodiments can be combined in any manner as long as there is no structural conflict. The present application is not limited to the particular embodiments disclosed herein, but rather includes all technical solutions falling within the scope of the claims.

What is claimed is:

1. An electrolyte solution for a lithium secondary battery, wherein the electrolyte solution for a lithium secondary battery comprises a sulfate and fluorosulfonate ions, and a molar ratio of the sulfate to the fluorosulfonate ions is (8-223):1.

2. The electrolyte solution for a lithium secondary battery according to claim 1, wherein the molar ratio of the sulfate to the fluorosulfonate ions is (10-60):1, and optionally (16.7-50):1.

3. The electrolyte solution for a lithium secondary battery according to claim 1, wherein the molar concentration of the sulfate in the electrolyte solution for a lithium secondary battery is 0.08 mol/L-0.2 mol/L, and optionally 0.1 mol/L-0.15 mol/L.

4. The electrolyte solution for a lithium secondary battery according to claim 1, wherein the molar concentration of the fluorosulfonate ions in the electrolyte solution for a lithium secondary battery is 0.0009 mol/L-0.009 mol/L, and optionally 0.003 mol/L-0.006 mol/L.

5. The electrolyte solution for a lithium secondary battery according to claim 1, wherein the sulfate comprises at least one of ethylene sulfate, 4-methyl ethylene sulfate, 4-fluoroethylene sulfate, 4-n-propyl ethylene sulfate, and 4,4′-bis(ethylene sulfate).

6. The electrolyte solution for a lithium secondary battery according to claim 1, wherein the fluorosulfonate ions are ASO₃F, wherein A comprises at least one of Li, Na, K, and H.

7. The electrolyte solution for a lithium secondary battery according to claim 1, wherein the electrolyte solution for a lithium secondary battery further comprises a positive electrode film-forming additive.

8. The electrolyte solution for a lithium secondary battery according to claim 7, wherein the positive electrode film-forming additive comprises at least one of fluoroethylene carbonate and 1,3-propanesultone.

9. The electrolyte solution for a lithium secondary battery according to claim 7, wherein a ratio of the molar amount of the positive electrode film-forming additive to a sum of the molar amounts of the sulfate and the fluorosulfonate ions in the electrolyte solution for a lithium secondary battery is (0.05-0.37):1, and optionally (0.06-0.3):1.

10. The electrolyte solution for a lithium secondary battery according to claim 7, wherein the molar concentration of the positive electrode film-forming additive in the electrolyte solution for a lithium secondary battery is 0.01 mol/L-0.03 mol/L.

11. The electrolyte solution for a lithium secondary battery according to claim 1, wherein the electrolyte solution for a lithium secondary battery further comprises difluorophosphate ions.

12. The electrolyte solution for a lithium secondary battery according to claim 11, wherein a ratio of the molar amount of the difluorophosphate ions to a sum of the molar amounts of the sulfate and the fluorosulfonate ions in the electrolyte solution for a lithium secondary battery is (0.048-1):1, and optionally (0.13-0.58):1.

13. The electrolyte solution for a lithium secondary battery according to claim 11, wherein the molar concentration of the difluorophosphate ions in the electrolyte solution for a lithium secondary battery is 0.01 mol/L-0.08 mol/L, and optionally 0.02 mol/L-0.06 mol/L.

14. The electrolyte solution for a lithium secondary battery according to claim 11, wherein the difluorophosphate ions are MPO₂F₂, wherein M comprises at least one of Li, Na, K, and H.

15. The electrolyte solution for a lithium secondary battery according to claim 1, wherein the electrolyte solution for a lithium secondary battery further comprises tetrafluoroborate ions.

16. The electrolyte solution for a lithium secondary battery according to claim 15, wherein a ratio of the molar amount of the tetrafluoroborate ions to a sum of the molar amounts of the sulfate and the fluorosulfonate ions in the electrolyte solution for a lithium secondary battery is (0.0024-0.012):1, and optionally (0.0038-0.008):1.

17. The electrolyte solution for a lithium secondary battery according to claim 15, wherein the molar concentration of the tetrafluoroborate ions in the electrolyte solution for a lithium secondary battery is 0.0005 mol/L-0.001 mol/L, and optionally 0.0006 mol/L-0.0008 mol/L.

18. The electrolyte solution for a lithium secondary battery according to claim 15, wherein the tetrafluoroborate ions are provided by at least one of the following substances: tetrafluoroboric acid, sodium tetrafluoroborate, potassium tetrafluoroborate, and lithium tetrafluoroborate.

19. The electrolyte solution for a lithium secondary battery according to claim 1, wherein the electrolyte solution for a lithium secondary battery satisfies at least one of the following conditions:
the content of water in the electrolyte solution for a lithium secondary battery is less than or equal to 20 ppm;
the content of HF in the electrolyte solution for a lithium secondary battery is less than or equal to 150 ppm.

20. A secondary battery, wherein the secondary battery comprises the electrolyte solution for a lithium secondary battery according to claim 1.

21. The secondary battery according to claim 20, wherein the secondary battery comprises a positive electrode active material, and the positive electrode active material comprises LiₓNi_{(1-y-z)}Co_{y}M_{z}O_{2-b}, wherein M comprises at least one of Mn, Al, Fe, Ti, Mg, Cr, Ga, Cu, Zn, Nb, and Zr, 0<x≤1.2, 0.05≤y≤0.8, 0.01≤z≤0.5, and 0≤b≤0.2.

22. The secondary battery according to claim 21, wherein the BET specific surface area of the positive electrode active material is less than or equal to 3 m²/g, and optionally, the BET specific surface area of the positive electrode active material is 1 m²/g-2.5 m²/g.

23. An electrical device, comprising the secondary battery according to claim 20.
